(19) United States
(12) Patent Application Publication
(10) Pub. No.: US 2025/0174192 A1
(43) Pub. Date: May 29, 2025

(54) DISPLAY DEVICE AND METHOD OF OPERATING A DISPLAY DEVICE

(71) Applicant: Samsung Display Co., Ltd., Yongin-si (KR)

(72) Inventors: Jungeon An, Yongin-si (KR); KIHYUN PYUN, Yongin-si (KR)

(21) Appl. No.: 18/944,577

(22) Filed: Nov. 12, 2024

(30) Foreign Application Priority Data
Nov. 27, 2023 (KR) 10-2023-0167046

(51) Int. Cl. G09G 3/3233; G09G 3/32

(52) U.S. Cl. CPC G09G 3/3233; G09G 3/32; G09G 2300/0842; G09G 2310/0251; G09G 2310/08; G09G 2320/0276; G09G 2320/0285; G09G 2320/029; G09G 2320/0626; G09G 2330/021; G09G 2340/0435

(57) ABSTRACT

A display device includes a display panel including a pixel and panel driver configured to apply an initialization voltage to the pixel in a first pre-charge period included in an active period of a frame period, to apply a data voltage to the pixel, to perform a sensing operation to the pixel in a sensing period included in a blank period of the frame period, to apply the initialization voltage to the pixel in a second pre-charge period included in the blank period and to apply a previous data voltage to the pixel in a previous frame writing period included in the blank period. The panel driver may change one of a length of the first pre-charge period and a length of the second pre-charge period based on a frame rate.

This application claims priority to Korean Patent Application No. 10-2023-0167046, filed on Nov. 27, 2023, and all the benefits accruing therefrom under 35 USC § 119, the content of which in its entirety is herein incorporated by reference.

### BACKGROUND

### 1. Field

The invention relates to a display device, and more particularly to a display device which performs a sensing operation, and a method of operating the display device.

### 2. Description of the Related Art

Even when a plurality of pixels included in a display device, such as an organic light emitting diode (OLED) display device, is manufactured by the same process, driving transistors of the plurality of pixels may have different driving characteristics (e.g., different mobility and/or different threshold voltages) from each other due to a process variation, or the like. Thus, the plurality of pixels may emit light having different luminance. Further, as the display device operates over time, the plurality of pixels may become degraded, and thus, the driving characteristics of the driving transistors may become degraded.

### SUMMARY

Some embodiments provide a display device that is capable of preventing the luminance of a pixel from being increased while a sensing operation is being performed in a blank period.

Some embodiments provide a method of operating a display device that is capable of preventing luminance of a pixel from being increased while a sensing operation is being performed in a blank period.

According to an embodiment, a display device may include a display panel including a pixel and panel driver configured to apply an initialization voltage to the pixel in a first pre-charge period included in an active period of a frame period, configured to apply data voltage to the pixel, to perform a sensing operation to the pixel in a sensing period included in a blank period of the frame period, to apply the initialization voltage to the pixel in a second pre-charge period included in the blank period and to apply a previous data voltage to the pixel in a previous frame writing period included in the blank period. The panel driver may change one of a length of the first pre-charge period and a length of the second pre-charge period based on a frame rate.

In an embodiment, a gate-source voltage of a driving transistor of the at least one pixel, after the previous data voltage is applied within the blank period, may be equal to or less than a gate-source voltage of the driving transistor of the at least one pixel in the active period.

In an embodiment, the panel driver may change the length of the first pre-charge period based on a first look-up table in which the first pre-charge period gradually decreases as the frame rate increases.

In an embodiment, the panel driver may change the length of the second pre-charge period based on a second look-up table in which the second pre-charge period gradually increases as the frame rate increases.

In an embodiment, the panel driver may increase the length of the first pre-charge period compared with a length of a reference pre-charge period, and the panel driver is configured to decrease the length of the second pre-charge period compared with the length of the reference pre-charge period.

In an embodiment, as the frame rate decreases, the panel driver may further increase the length of the first pre-charge period, and the panel driver is configured to further decrease the length of the second pre-charge period.

In an embodiment, the pixel may include a driving transistor including a gate connected to a gate node, a first terminal connected to a line of a first supply voltage and a second terminal connected to a source node, a scan transistor including a gate receiving a scan signal, a first terminal connected to a data line and a second terminal connected to the gate node, a sensing transistor including a gate receiving a sensing signal, a first terminal connected to a sensing line and a second terminal connected to the source node, a storage capacitor including a first electrode connected to the gate node and the second electrode connected to the source node and a light emitting element including an anode connected to the source node and a cathode connected to a line of a second power supply voltage.

In an embodiment, the panel driver may include a frame rate determining circuit configured to determine the frame rate of the display panel, a pre-charge set-up circuit configured to receive a maximum frame rate of the display panel and a minimum frame rate of the display panel and configured to output a final pre-charge look-up table, a timing controller configured to receive a present frame rate from the frame rate determining circuit, configured to receive the final pre-charge look-up table from the pre-charge set-up circuit and configured to output a gate width signal and a signal generator configured to receive the gate width signal and configured to output a scan signal and a sensing signal.

In an embodiment, the pre-charge set-up circuit may include a first pre-charge set-up circuit configured to receive the maximum frame rate and the minimum frame rate and configured to generate a first look-up table in which the first pre-charge period gradually decreases as the frame rate increases and a second pre-charge set-up circuit configured to receive the maximum frame rate and the minimum frame rate and configured to generate a second look-up table in which the second pre-charge period gradually increases as the frame rate increases. The final pre-charge look-up table may be generated based on the first look-up table and the second look-up table.

In an embodiment, in the first pre-charge period, the timing controller may increase a length of a gate width signal activation level period to be larger than a length of a reference gate width signal activation level period. In the second pre-charge period, the timing controller may decrease the length of the gate width signal activation level period to be smaller than the length of the reference gate width signal activation level period.

In an embodiment, the signal generator may output the scan signal and the sensing signal having an activation level in the gate width signal activation level period.

In an embodiment, as the frame rate decreases, in the first pre-charge period, the timing controller may further increase a length of a gate width signal activation level period. As the frame rate decreases, in the second pre-charge period, the timing controller may further decrease the length of the gate width signal activation level period.

In an embodiment, the signal generator may output the scan signal and the sensing signal having an activation level in the gate width signal activation level period.

According to an embodiment, a display device may include a pixel including a driving transistor, a scan transistor, a sensing transistor and a light emitting element, a display panel including the pixel and a panel driver configured to apply an initialization voltage to the driving transistor through the sensing transistor in a first pre-charge period included in an active period of a frame period, to apply data voltage to the driving transistor through the scan transistor in a data writing period included in the active period, to perform a sensing operation to the driving transistor in a sensing period included in a blank period of the frame period, to apply the initialization voltage to the driving transistor through the sensing transistor in a second pre-charge period included in the blank period and to apply a previous data voltage to the driving transistor through the scan transistor in a previous frame writing period included in the blank period. A length of the first pre-charge period and a length of the second pre-charge period are different from each other.

According to an embodiment, there is provided a method of operating a display device. The method may include changing one of a length of a first pre-charge period included in an active period of a frame period and a length of the second pre-charge period included in a blank period of the frame period based on a present frame rate, applying an initialization voltage to at least one pixel of pixels in the first pre-charge period, sequentially applying data voltages to pixels on a row basis in a data writing period included in the active period, performing a sensing operation on the least one pixel in a sensing period included in the blank period, applying the initialization voltage to the least one pixel in the second pre-charge period and applying a previous data voltage to the least one pixel in a previous frame data writing period included in the blank period.

In an embodiment, a gate-source voltage of a driving transistor of the at least one pixel after the previous data voltage may be applied in the blank period is equal to or less than a gate-source voltage of the driving transistor of the at least one pixel in the active period.

In an embodiment, the length of the first pre-charge period may be increased compared with a length of a reference pre-charge period and the length of the second pre-charge period may be decreased compared with the length of the reference pre-charge period.

In an embodiment, the length of the first pre-charge period may be gradually decreased as the frame rate increases. The second pre-charge period is gradually increased as the frame rate increases.

In an embodiment, as the frame rate decreases, the length of the first pre-charge period may be further increased and a length of the second pre-charge period may be further decreased.

In an embodiment, as the frame rate increases, the first pre-charge period may be gradually decreased, and the second pre-charge period may be gradually increased.

As described above, in a display device and a method of operating the display device according to an embodiment, a data voltage may be applied to a pixel in an active period of a frame period and a sensing operation may be performed on the pixel in a blank period of the frame period. The active period and the blank period may include a pre-charge period, respectively. A length of the pre-charge period may be changed according to a frame rate. Accordingly, luminance of the pixel on which the sensing operation is performed in the blank period may be prevented from being increased.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device, according to an embodiment.

FIG. 2 is a schematic circuit diagram illustrating an example of a pixel included in a display device, according to an embodiment.

FIG. 3 is a block diagram illustrating a panel driver, according to an embodiment.

FIG. 4 is a graph illustrating a first look-up table generated by a panel driver, according to an embodiment.

FIG. 5 is a graph illustrating a second look-up table generated by a panel driver, according to an embodiment.

FIG. 6 is a schematic circuit diagram illustrating an example of a pixel receiving a data voltage of a conventional display device in an active period and a blank period, according to an embodiment.

FIG. 7 is a schematic diagram illustrating an example of a pixel receiving a data voltage of a display device in a high frame rate mode, according to an embodiment.

FIG. 8 is a schematic diagram illustrating an example of a pixel receiving a data voltage of a display device in a low frame rate mode, according to an embodiment.

FIG. 9 is a timing diagram illustrating an example of a pixel included in a conventional display device in a high frame rate mode and a low frame rate mode and an example of a pixel included in a display device, according to an embodiment, in a high frame rate mode and a low frame rate mode.

FIG. 10 is a flowchart illustrating a method of operating a display device, according to an embodiment.

FIG. 11 is a block diagram illustrating an electronic device including a display device, according to an embodiment.

FIG. 12 is a block diagram illustrating an example of an electronic device, according to an embodiment.

### DETAILED DESCRIPTION

Hereinafter, embodiments of the invention will be explained in detail with reference to the accompanying drawings. The same reference numerals are used for the same components in the drawings, and redundant descriptions of the same components will be omitted.

It will be understood that when an element (or a region, a layer, a portion, or the like) is referred to as being related to another such as being “on”, “connected to” or “coupled to” another element, it may be directly disposed on, connected or coupled to the other element, or intervening elements may be disposed therebetween.

Like reference numerals or symbols refer to like elements throughout. In the drawings, the thickness, the ratio, and the size of the element are exaggerated for effective description of the technical contents. As used herein, the term “and/or” includes any and all combinations of one or more of the associated listed items.

The term “and/or,” may include all combinations of one or more of which associated configurations may define.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the scope of the inventive concept. Similarly, a second element, component, region, layer or section may be termed a first element, component, region, layer or section. As used herein, the singular forms, “a”, “an” and “the” are intended to include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

It will be further understood that the terms “comprise”, “includes” and/or “have”, when used in this specification, specify the presence of stated features, integers, steps, operations, elements, components, and/or groups thereof, but do not preclude the presence or addition of one or more other features, integers, steps, operations, elements, components, and/or groups thereof. As used herein, being “disposed directly on” may mean that there is no additional layer, film, region, plate, or the like between a part and another part such as a layer, a film, a region, a plate, or the like. For example, being “disposed directly on” may mean that two layers or two members are disposed without using an additional member such as an adhesive member, therebetween.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

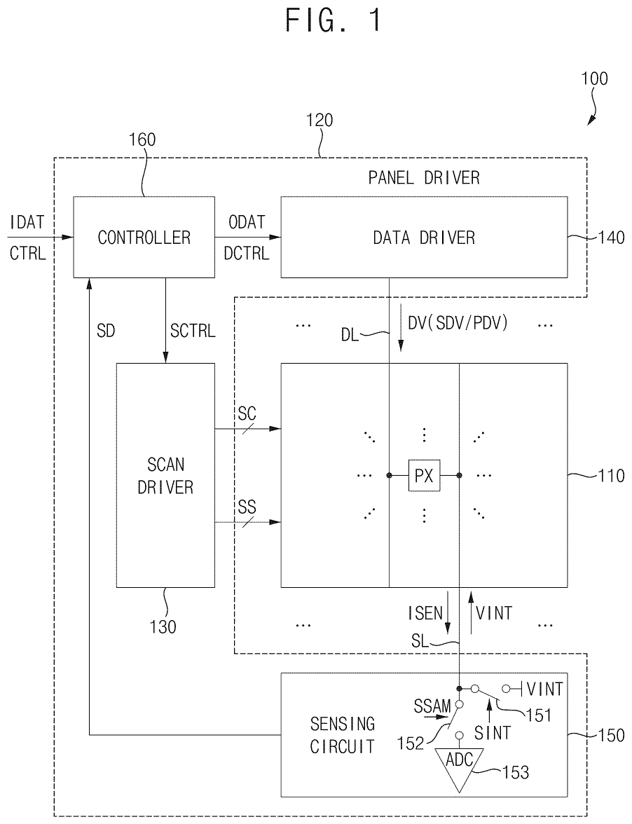

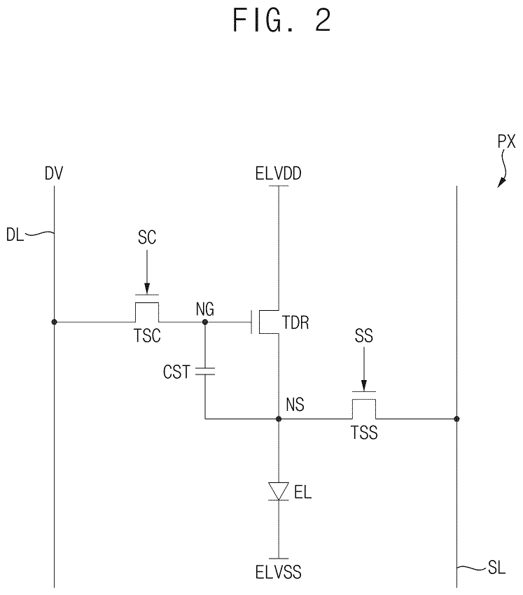

FIG. 1 is a block diagram illustrating a display device, according to an embodiment, and FIG. 2 is a circuit diagram illustrating an example of a pixel included in a display device, according to an embodiment.

In an embodiment and referring to FIG. 1, a display device 100 may include a display panel 110 that includes pixels PX, and a panel driver 120 that drives the display panel 110. In some embodiments, the panel driver 120 may include a scan driver 130 that provides scan signals SC and sensing signals SS to the pixels PX, a data driver 140 coupled to the pixels PX through data lines DL, a sensing circuit 150 coupled to the pixels PX through sensing lines SL, and a controller 160 that controls the scan driver 130, the data driver 140 and the sensing circuit 150.

In an embodiment, the display panel 110 may include the data lines DL, the sensing lines SL, and the pixels PX connected to the data lines DL and the sensing lines SL. Additionally, the display panel 110 may further include scan signal lines for providing the scan signals SC to the pixels PX, and sensing signal lines for providing the sensing signals SS to the pixels PX. In some embodiments, each pixel PX may include a light emitting element, and the display panel 110 may be a light emitting display panel. For example, in an embodiment, the display panel 110 may be, but is not limited to, an organic light emitting diode (OLED) display panel, a quantum dot (QD) display panel, or the like.

In an embodiment and as illustrated in FIG. 2, each pixel PX may include a driving transistor TDR, a scan transistor TSC, a sensing transistor TSS, a storage capacitor CST and a light emitting element EL.

The storage capacitor CST may store a data voltage DV (or a sensing data voltage SDV or a previous data voltage PDV) transferred through the data line DL. In an embodiment, the storage capacitor CST may include a first electrode coupled to a gate node NG, and a second electrode coupled to a source node NS.

The scan transistor TSC may couple the data line DL to the gate node NG in response to the scan signal SC. Thus, the scan transistor TSC may transfer the data voltage DV of the data line DL to the gate node NG in response to the scan signal SC. In an embodiment, the scan transistor TSC may include a gate receiving the scan signal SC, a first terminal coupled to the data line DL, and a second terminal coupled to the gate node NG.

The sensing transistor TSS may couple the sensing line SL to the source node NS in response to the sensing signal SS. In an embodiment, the sensing transistor TSS may include a gate receiving the sensing signal SS, a first terminal coupled to the sensing line SL, and a source coupled to the source node NS.

The driving transistor TDR may generate a driving current based on the data voltage DV stored in the storage capacitor CST. In an embodiment, the driving transistor TDR may include a gate coupled to the gate node NG, a first terminal (e.g., a drain) coupled to a line of a first power supply voltage ELVDD (e.g., a high power supply voltage), and a second terminal (e.g., a source) coupled to the source node NS.

The light emitting element EL may emit light in response to the driving current generated by the driving transistor TDR. According to embodiments, the light emitting element EL may be, but is not limited to, an OLED, a QD diode, or the like. In an embodiment, the light emitting element EL may include an anode coupled to the source node NS, and a cathode coupled to a line of a second power supply voltage ELVSS (e.g., a low power supply voltage).

Although FIG. 2 illustrates one embodiment of the pixel PX, the pixel PX of the display device 100, is not limited to the embodiment of FIG. 2.

In an embodiment, the scan driver 130 may generate the scan signals SC and the sensing signals SS based on a scan control signal SCTRL from the controller 160, and may sequentially provide the scan signals SC and the sensing signals SS to the pixels PX on a row basis during an active period of a frame period. Thus, in the active period, the scan driver 130 may substantially simultaneously provide the scan signal SC and the sensing signal SS to a current row of the pixels PX, and then may substantially simultaneously provide the scan signal SC and the sensing signal SS to the next row of the pixels PX.

In an embodiment, the scan control signal SCTRL may include, but is not limited to, a start signal and a clock signal. In some embodiments, the scan driver 130 may be integrated or may be formed in a peripheral portion of the display panel 110. In other embodiments, the scan driver 130 may be implemented with one or more integrated circuits.

In an embodiment, the data driver 140 may generate the data voltages DV based on output image data ODAT and a data control signal DCTRL received from the controller 160, and may provide the data voltages DV to the pixels PX during the active period. Since the scan signals SC and the sensing signals SS are sequentially provided to the pixels PX on the row basis in the active period, the data driver 140 may sequentially apply the data voltages DV to the pixels PX on the row basis in the active period. In an embodiment, during the active period, a period in which the data voltages DV are applied to the pixels PX sequentially may be called a data writing period. Additionally, in an embodiment, during the active period, an initialization voltage VINT may be applied to at least one pixel of the pixels PX before the period in which data voltages DV are sequentially applied to the pixels PX in the active period. For example, a period in which the at least one pixel PX receives the initialization voltage VINT may be called as a first pre-charge period. In some embodiments, the data control signal DCTRL may include, but is not limited to, a data enable signal, a horizontal start signal and a load signal.

The data driver 140 may apply the sensing data voltage SDV to at least one pixel PX on which a sensing operation is performed during a blank period of the frame period. Additionally, within the blank period, the data driver 140 may apply the previous data voltage PDV to the at least one pixel PX after the sensing operation is performed. In some embodiments, the previous data voltage PDV may be a data voltage DV that is applied to the at least one pixel PX in the active period immediately before the sensing operation is performed. In the present embodiment, in the blank period, after the sensing operation is performed, a period in which the data driver 140 applies the previous data voltage PDV to the at least one pixel PX may be called a previous frame data writing period.

In an embodiment, after performing the sensing operation on the least one pixel PX, the panel driver 120 applies the initialization voltage VINT to the at least one pixel PX before the previous frame data writing period. A period in which the initialization voltage VINT is applied to the at least one pixel PX before the previous frame data writing period after performing the sensing operation for the least one pixel PX may be called a second pre-charge period.

In an embodiment, the data driver 140 may be implemented with one or more integrated circuits. In other embodiments, the data driver 140 and the controller 160 may be implemented with a single integrated circuit, and the single integrated circuit may be referred to as a timing controller embedded data driver (TED) integrated circuit.

In an embodiment, the sensing circuit 150 may generate sensing data SD by sensing the at least one pixel PX through the sensing line SL. For example, the sensing circuit 150 may sense a driving characteristic (e.g., a mobility and/or a threshold voltage) of the driving transistor TDR by measuring a sensing current ISEN (or a sensing voltage) of the driving transistor TDR of the at least one pixel PX through the sensing line SL. In some embodiments, the sensing circuit 150 may include, but is not limited to, an initialization switch 151 that provides an initialization voltage VINT to the sensing line SL in response to an initialization signal SINT, a sampling switch 152 that couples the sensing line SL to an analog-to-digital converter (ADC) 153 in response to a sampling signal SSAM, and the ADC 153 that generates the sensing data SD based on the sensing current ISEN (or the sensing voltage) of the driving transistor TDR received through the sensing line SL. In an embodiment, the sensing circuit 150 may be implemented with a separate integrated circuit from an integrated circuit of the data driver 140. In other embodiments, the sensing circuit 150 may be included in the data driver 140, or may be included in the controller 160.

In an embodiment, the controller 160 (e.g., a timing controller (TCON)) may receive input image data IDAT and a control signal CTRL from an external host processor (e.g., a graphics processing unit (GPU), an application processor (AP) or a graphics card). In some embodiments, the control signal CTRL may include, but is not limited to, a vertical synchronization signal, a horizontal synchronization signal, an input data enable signal, a master clock signal, etc. The controller 160 may generate the output image data ODAT by correcting the input image data IDAT based on the sensing data SD received from the sensing circuit 150. Further, the controller 160 may generate the data control signal DCTRL and the scan control signal SCTRL based on the control signal CTRL. The controller 160 may control an operation of the scan driver 130 by providing the scan control signal SCTRL to the scan driver 130, and may control an operation of the data driver 140 by providing the output image data ODAT and the data control signal DCTRL to the data driver 140.

In the display device 100, according to an embodiment, the panel driver 120 may perform a sensing operation (or a real-time sensing operation) for at least one pixel PX of the display panel 110 during a blank period (e.g., a vertical blank period) of a frame period. In some embodiments, the panel driver 120 may perform the sensing operation on one row of the pixels PX in each blank period. For example, the panel driver 120 may sequentially perform the sensing operations for a plurality of pixel rows of the display panel 110 in a plurality of frame periods. Thus, in a case where the display panel 110 includes N pixel rows, the panel driver 120 may perform the sensing operations for the N pixel rows in N blank periods of N frame periods, respectively, where Nis an integer greater than 1. In another example, the panel driver 120 may perform the sensing operation on one pixel row that is randomly selected in each frame period.

In an embodiment, after the sensing operation for the at least one pixel PX is performed, the previous data voltage PDV may be applied to the pixel PX such that the pixel PX again emits light. However, in a conventional display device, a voltage of the source node NS of the pixel PX when the data voltage DV is applied to the pixel PX (or when data writing is performed) during an active period and the voltage of the source node NS of the pixel PX when the previous data voltage PDV is applied to the pixel PX (or when recovery data writing is performed) after the sensing operation is performed may be different from each other, and thus a gate-source voltage of the driving transistor TDR after the recovery data writing in the blank period may be different from the gate-source voltage of the driving transistor TDR after the data writing in the active period.

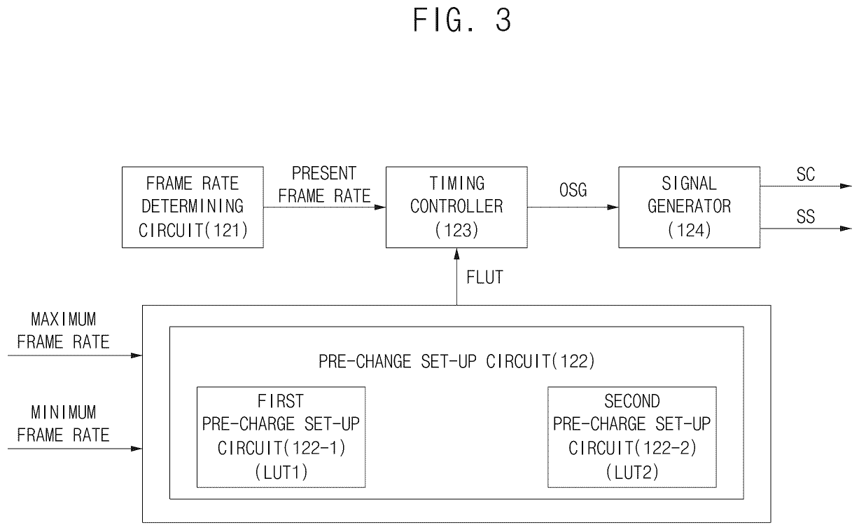

FIG. 3 is a block diagram illustrating a panel driver 120, according to an embodiment.

In an embodiment and referring to FIG. 3, the panel driver 120 may include a frame rate determining circuit 121, a pre-charge set-up circuit 122, a timing controller 123 and a signal generator 124. The pre-charge set-up circuit 122 may include a first pre-charge set-up circuit 122-1 and a second pre-charge set-up circuit 122-2.

The frame rate determining circuit 121 may output a present frame rate based on the input image data IDAT and the control signal CTRL. The frame rate determining circuit 121 may apply the present frame rate to the timing controller 123.

The first pre-charge set-up circuit 122-1 may receive a maximum frame rate and a minimum frame rate and may generate a first look-up table LUT1 in which the first pre-charge period gradually decreases as the frame rate increases. For example, the maximum frame rate may be a maximum value of frame rate of input image applied to the display device of the invention. Additionally, the minimum frame rate may be a minimum value of frame rate of input image applied to the display device of the invention. The first look-up table LUT1 may be set so that the first pre-charge period may gradually decrease as the frame rate increases from the minimum frame rate to the maximum frame rate.

In a conventional display device, a conventional pre-charge period is a period in which the at least one pixel PX receives the initialization voltage VINT before the data voltages DV are sequentially applied to the pixels PX on a row basis in the active period or a period in which the at least one pixel PX receives the initialization voltage VINT before a previous frame voltage is applied to the at least one pixel PX in the blank period. The conventional pre-charge period may be called a reference pre-charge period.

In an embodiment, in the first pre-charge period the initialization voltage VINT may be applied to the at least one pixel PX before the data writing period.

The second pre-charge set-up circuit 122-2 may receive a maximum frame rate and a minimum frame rate and may generate a second look-up table LUT2 in which the second pre-charge period gradually increases as the frame rate increases. The second look-up table LUT2 may be set so that the second pre-charge period may gradually increase as the frame rate increases from the minimum frame rate to the maximum frame rate.

The pre-charge set-up circuit 122 may generate a final pre-charge look-up table FLUT based on the first look-up table LUT1 and the second look-up table LUT2. The final pre-charge look-up table FLUT may be set so that the first pre-charge period may gradually decrease as the frame rate increases and the second pre-charge period may gradually increase as the frame rate increases.

The timing controller 123 may receive the present frame rate from the frame rate determining circuit 121, may receive the final pre-charge look-up table FLUT from the pre-charge set-up circuit 122 and may generate a gate width signal OSG.

The signal generator 124 may receive the gate width signal OSG and may output the scan signals SC and the sensing signals SS. In an embodiment, in a gate width signal activation level period in which the gate width signal OSG has an activation level, the scan signals SC and the sensing signals SS may have an activation level.

It should be appreciated that in a conventional display device, the gate width signal OSG may be output such that the scan signals SC and the sensing signals SS have the activation level. A period in which the conventional display device outputs the gate width signal OSG having the activation level may be a conventional gate width signal activation level period. The conventional gate width signal activation level period may be referred to as the reference gate width signal activation level period of the invention.

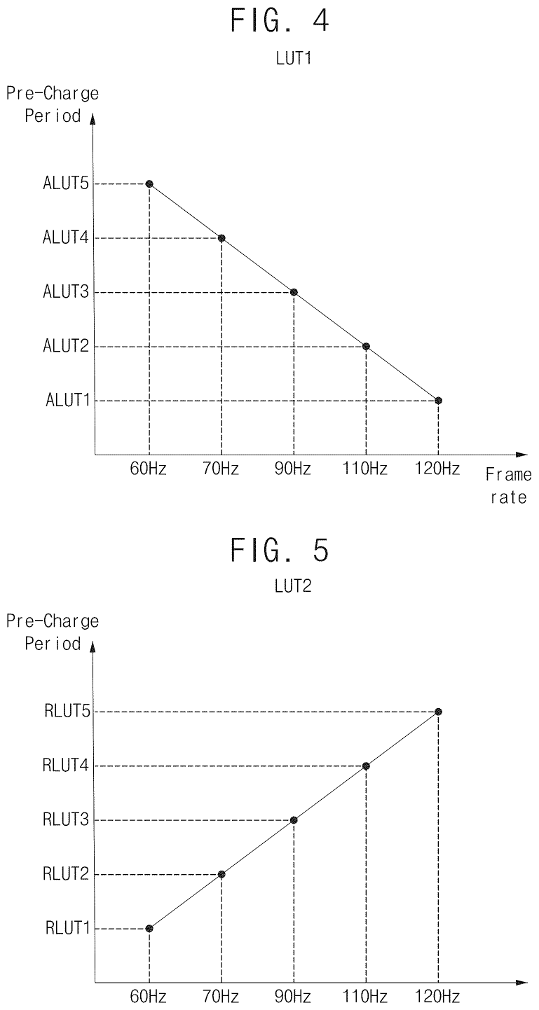

FIG. 4 is a graph illustrating a first look-up table LUT1 generated by a panel driver, according to an embodiment.

In an embodiment, the first look-up table LUT1 may be set so that the first pre-charge period may gradually decrease as the frame rate increases. For example, when the frame rate is about 60 Hz, the first pre-charge period may have a fifth period ALUT5. When the frame rate is about 120 Hz, the first pre-charge period may have a first period ALUT1 which is shorter than the fifth period ALUT5.

FIG. 5 is a graph illustrating a second look-up table which is generated by a panel driver, according to an embodiment.

The second look-up table LUT2 may be set so that the second pre-charge period may gradually increase as the frame rate increases. For example, when the frame rate is about 60 Hz, the second pre-charge period may have a fifth period RLUT1. When the frame rate is about 120 Hz, the second pre-charge period may have a fifth period RLUT5 which is longer than the first period RLUT1.

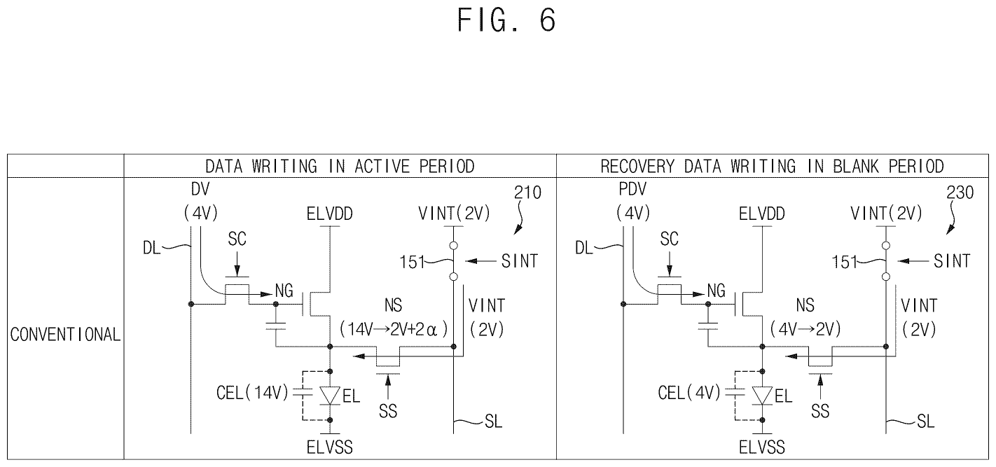

FIG. 6 is a circuit diagram illustrating an example of a pixel receiving a data voltage of a conventional display device during an active period and a blank period.

As illustrated in FIG. 6, when the data writing is initiated in the active period, since a pixel 210 of the conventional display device is in a light-emission state, the source node NS may have a voltage (e.g., about 14V) that is higher than a threshold voltage (e.g., about 12V) of the light emitting element EL and a parasitic capacitor CEL of the light emitting element EL may be in a charged state to store the voltage of about 14V. To perform the data writing in the active period, the data voltage DV (e.g., of about 4V) may be applied to the gate node NG. Additionally, the initialization switch 151 may be turned on in response to the initialization signal SINT to provide the initialization voltage VINT (e.g., of about 2V) to the sensing line SL wherein the initialization voltage VINT may be applied to the source node NS through the sensing line SL. Since, when the data writing is performed in the active period, the source node NS has the high voltage of about 14V and the parasitic capacitor CEL of the light emitting element EL is in the charged state, after the data writing, the voltage of the source node NS may not be decreased to the initialization voltage VINT of about 2V, and the source node NS may have a voltage of 2V+2α, where a certain voltage 2α is added to the initialization voltage VINT of about 2V. Accordingly, the gate-source voltage of the driving transistor TDR of the pixel 210 of the conventional display device, after the data writing in the active period, may be about 2V-2α.

However, when the recovery data writing is initiated after the sensing operation within the blank period, since a pixel 230 of the conventional display device is in a non-light-emission state, the source node NS may have a relatively low voltage (e.g., about 4V). To perform the recovery data writing in the blank period, the previous data voltage PDV which may be substantially the same as the data voltage DV of about 4V in the active period may be applied to the gate node NG. Additionally, the initialization switch 151 may be turned on in response to the initialization signal SINT to provide the initialization voltage VINT of about 2V to the sensing line SL, and the initialization voltage VINT may be applied to the source node NS through the sensing line SL. Since the source node NS has the low voltage of about 4V when the recovery data writing is performed in the blank period, after the recovery data writing, the voltage of the source node NS may be decreased to the initialization voltage VINT of about 2V. Accordingly, in the conventional display device, although the gate-source voltage of the driving transistor TDR of the pixel 210 after the data writing in the active period is about 2V-2α, the gate-source voltage of the driving transistor TDR of the pixel 210 after the recovery data writing in the blank period may be about 2V. Thus, in the conventional display device, luminance of the pixel PX or the pixel row on which the sensing operation is performed in the blank period may be increased, and a horizontal bright line may be perceived.

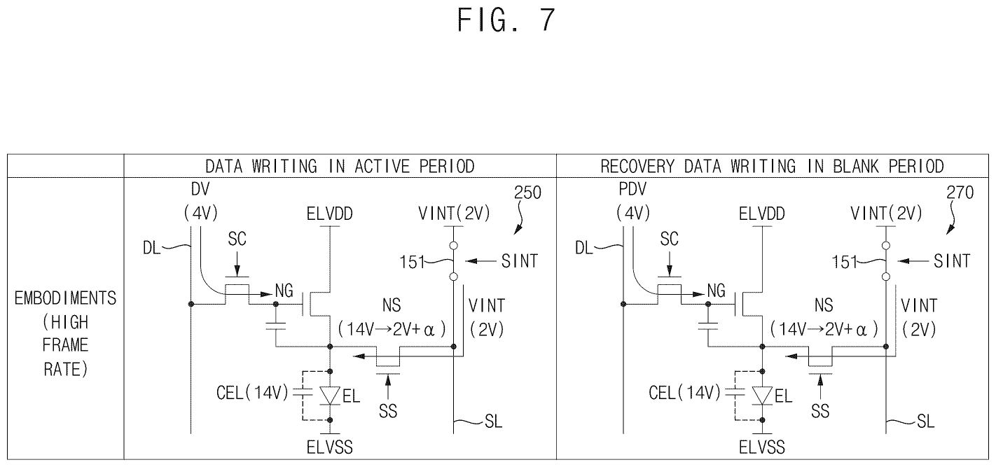

FIG. 7 is a diagram illustrating an example of a pixel receiving a data voltage of a display device in a high frame rate mode, according to an embodiment.

In an embodiment, a high frame rate mode may be operated when the frame rate exceeds about 90 Hz. However, the invention is not limited to a value of the frame rate. The high frame rate mode may be operated based on a value set by user. For example, in the high frame rate mode, the display panel may be driven at a second frame rate which is higher than a first frame rate. The first frame rate and the second frame rate is set by user. However, the invention is not limited to a value of the first frame rate and the invention is not limited to a value of the second frame rate.

In an embodiment, the panel driver 120 may change a length of the first pre-charge period and a length of the second pre-charge period.

In an embodiment, the length of the first pre-charge period and the length of the second pre-charge period are different. For example, the length of the first pre-charge period is longer than the length of the second pre-charge period. Accordingly, the gate-source voltage of the driving transistor TDR after the recovery data writing in the blank period may be substantially the same as the gate-source voltage of the driving transistor TDR after the data writing in the active period. Thus, a luminance of the pixel PX on which the sensing operation was performed may be prevented from increasing in the blank period.

In an embodiment, when the display device 100 is driven at the high frame rate mode, the panel driver 120 may increase the length of the first pre-charge period to be greater than a length of the reference pre-charge period and may decrease the length of the second pre-charge period to be smaller than the length of the reference pre-charge period. Accordingly, through the first pre-charge period is longer than the reference pre-charge period, when the data writing is performed in the active period, after the data writing, the voltage of the source node NS may be not about 2V+2α but rather about 2V+α. Thus, the gate-source voltage of the driving transistor TDR of the pixel 250 of the display device 100, according to an embodiment, after the data writing in the active period may be about 2V-α.

Additionally, though the second pre-charge period is shorter than the reference pre-charge period, the voltage of the source node NS may not be decreased to the initialization voltage VINT of about 2V, and the source node NS may have the voltage 2V+α, where the certain voltage α is added to the initialization voltage VINT of about 2V. Thus, the gate-source voltage of the driving transistor TDR of the pixel 270 of the display device 100, according to an embodiment, after the previous data voltage writing in the blank period may be about 2V-α.

By these operations, the voltage of the source node NS at a start time point of the recovery data writing (or applying the previous data voltage PDV) in the blank period may be substantially the same as the voltage of the source node NS at a start time point of the data writing in the active period. Accordingly, the gate-source voltage of the driving transistor TDR, after the recovery data writing in the blank period, may be substantially the same as the gate-source voltage of the driving transistor TDR after the data writing in the active period. Thus, in the display device 100, according to an embodiment, the luminance of the pixel PX on which the sensing operation is performed in the blank period may be prevented from being increased.

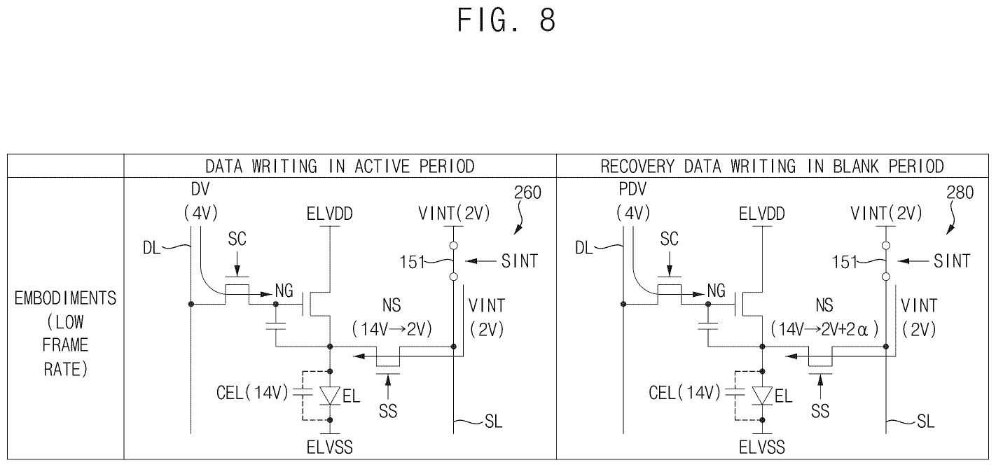

FIG. 8 is a diagram illustrating an example of a pixel receiving a data voltage of a display device in a low frame rate mode, according to an embodiment.

In an embodiment, a low frame rate mode may be operated when the frame rate is less than about 90 Hz. However, the invention is not limited to a value of the frame rate and the low frame rate mode may be operated based on a value set by user. For example, in an embodiment, in the low frame rate mode, the display panel may be driven at the first frame rate.

As describe above, the panel driver 120 may change the length of the first pre-charge period and the length of the second pre-charge period.

In an embodiment, when the display device 100 is driven at the low frame rate mode, the panel driver 120 may increase the length of the first pre-charge period to be larger than a length of the reference pre-charge period and may decrease the length of the second pre-charge period to be smaller than the length of the reference pre-charge period.

In an embodiment, when the display device 100 is driven at the low frame rate mode, the panel driver may increase the length of the first pre-charge period to be larger than the length of the first pre-charge period of the high frame rate mode and may decrease the length of the second pre-charge period to be smaller than the length of the second pre-charge period of the high frame rate mode. Accordingly, though the first pre-charge period is longer than the first pre-charge period of the high frame rate mode, when the data writing is performed in the active period, after the data writing, the voltage of the source node NS may be not about 2V+2α, but rather about 2V. Thus, the gate-source voltage of the driving transistor TDR of the pixel 250 of the display device 100, according to embodiments, after the data writing in the active period may be about 2V.

Additionally, though the second pre-charge period is shorter than the second pre-charge period of the high frame rate mode, the voltage of the source node NS may not be decreased to the initialization voltage VINT of about 2V, and the source node NS may have the voltage 2V+2α, where the certain voltage 2α is added to the initialization voltage VINT of about 2V. Thus, the gate-source voltage of the driving transistor TDR of the pixel 270 of the display device 100, according to an embodiment, after the previous data voltage writing in the blank period may be about 2V-2α.

By these operations, the voltage of the source node NS at a start time point of the recovery data writing (or applying the previous data voltage PDV) in the blank period may be substantially the same as (or higher than) the voltage of the source node NS at a start time point of the data writing in the active period. Accordingly, the gate-source voltage of the driving transistor TDR, after the recovery data writing in the blank period, may be substantially the same as (or lower than) the gate-source voltage of the driving transistor TDR after the data writing in the active period. When a frame rate of the conventional display device is low, the luminance of the conventional display device in the blank period is more increased and the horizontal bright line may be perceived.

In an embodiment, the gate-source voltage of the driving transistor TDR after the recovery data writing in the blank period may be substantially the same as (or lower than) the gate-source voltage of the driving transistor TDR after the data writing in the active period. Accordingly, the luminance of the pixel PX on which the sensing operation is performed in the blank period may be prevented from being increased.

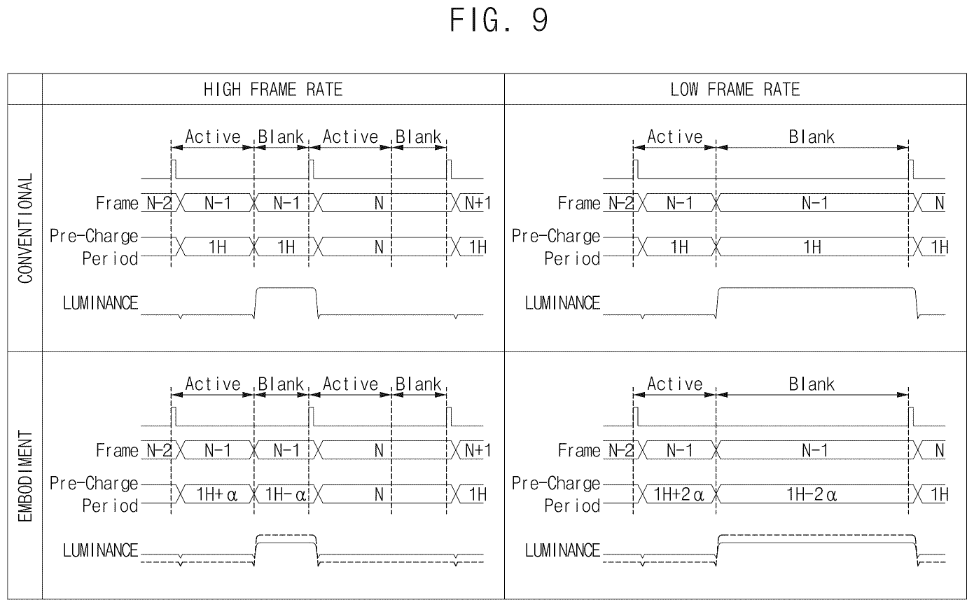

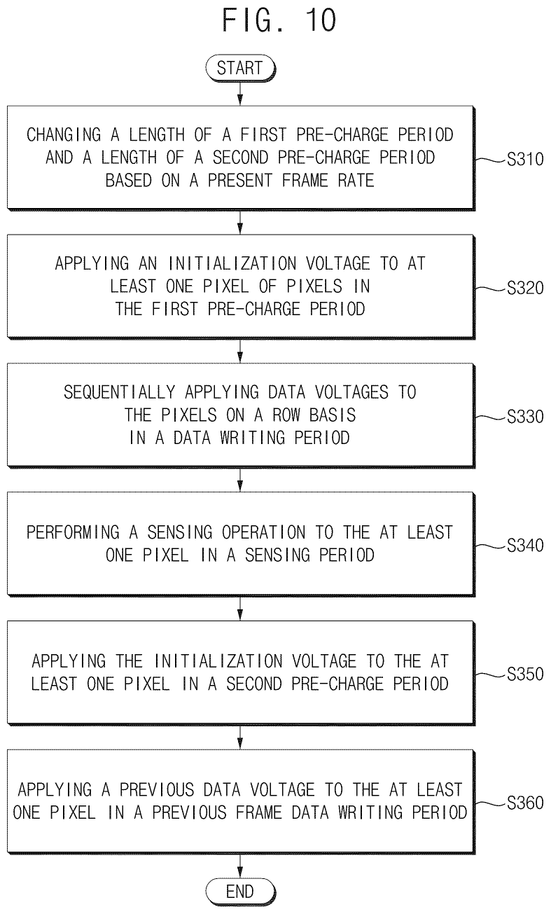

FIG. 9 is a timing diagram illustrating an example of a pixel included in a conventional display device in a high frame rate mode and a low frame rate mode and an example of a pixel included in a display device, according to an embodiment, in a high frame rate mode and a low frame rate mode.

In an embodiment and as described above, the panel driver 120 may change the length of the first pre-charge period and the length of the second pre-charge period. By these operations, the voltage of the source node NS at a start time point of the recovery data writing (or applying the previous data voltage PDV) in the blank period may be substantially the same as (or higher than) the voltage of the source node NS at a start time point of the data writing in the active period. Accordingly, the gate-source voltage of the driving transistor TDR, after the recovery data writing in the blank period, may be substantially the same as (or lower than) the gate-source voltage of the driving transistor TDR after the data writing in the active period. Thus, the luminance of the pixel PX on which the sensing operation is performed in the blank period may be prevented from being increased.

FIG. 10 is a flowchart illustrating a method of operating a display device, according to an embodiment.

In an embodiment and referring to FIG. 10, the panel driver 120 may change the length of the first pre-charge period and the length of the second pre-charge period based on the present frame rate (S310). The panel driver 120 may apply the initialization voltage VINT to the least one pixel in the first pre-charge period (S320). The panel driver 120 may sequentially apply the data voltages to the pixels on a row basis in the data writing period (S330). The panel driver 120 may perform the sensing operation to the at least one pixel in the sensing period (S340). The panel driver 120 may apply the initialization voltage VINT to the at least one pixel in the second pre-charge period (S350). The panel driver 120 may apply the previous data voltage to the at least one pixel in the previous frame data writing period (S360). Thus, the panel driver 120 may change the length of the first pre-charge period and the length of the second pre-charge period, so that the luminance of the pixel on which the sensing operation is performed in the blank period may be prevented from being increased.

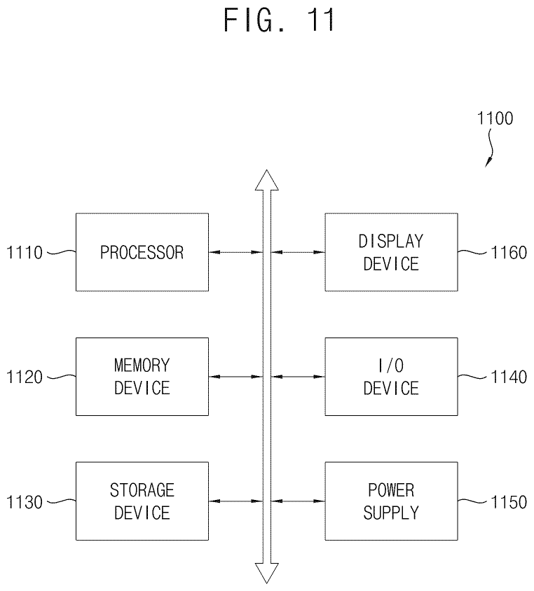

FIG. 11 is a block diagram illustrating an electronic device including a display device, according to an embodiment.

In an embodiment and referring to FIG. 11, an electronic device 1100 may include a processor 1110, a memory device 1120, a storage device 1130, an input/output (I/O) device 1140, a power supply 1150, and a display device 1160. The electronic device 1100 may further include a plurality of ports for communicating with a video card, a sound card, a memory card, a universal serial bus (USB) device, other electronic devices, etc.

In an embodiment, the processor 1110 may perform various computing functions or tasks. The processor 1110 may be an application processor (AP), a micro-processor, a central processing unit (CPU), etc. The processor 1110 may be coupled to other components via an address bus, a control bus, a data bus, etc. Further, in some embodiments, the processor 1110 may be further coupled to an extended bus such as a peripheral component interconnection (PCI) bus.

The memory device 1120 may store data for operations of the electronic device 1100. For example, in an embodiment, the memory device 1120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc.

In an embodiment, the storage device 1130 may be a solid state drive (SSD) device, a hard disk drive (HDD) device, a CD-ROM device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In an embodiment, in the display device 1160, a pre-charge data voltage may be applied to a pixel after a sensing operation for the pixel is performed in a blank period of a frame period, and a previous data voltage may be applied to the pixel after a predetermined time from a time point at which the pre-charge data voltage is applied. Accordingly, luminance of the pixel on which the sensing operation is performed in the blank period may be prevented from being increased.

The invention may be applied to any electronic device 1100 including the display device 1160. For example, in an embodiment, the invention may be applied to a television (TV), a digital TV, a 3D TV, a smart phone, a wearable electronic device, a tablet computer, a mobile phone, a personal computer (PC), a home appliance, a laptop computer, a personal digital assistant (PDA), a portable multimedia player (PMP), a digital camera, a music player, a portable game console, a navigation device, etc.

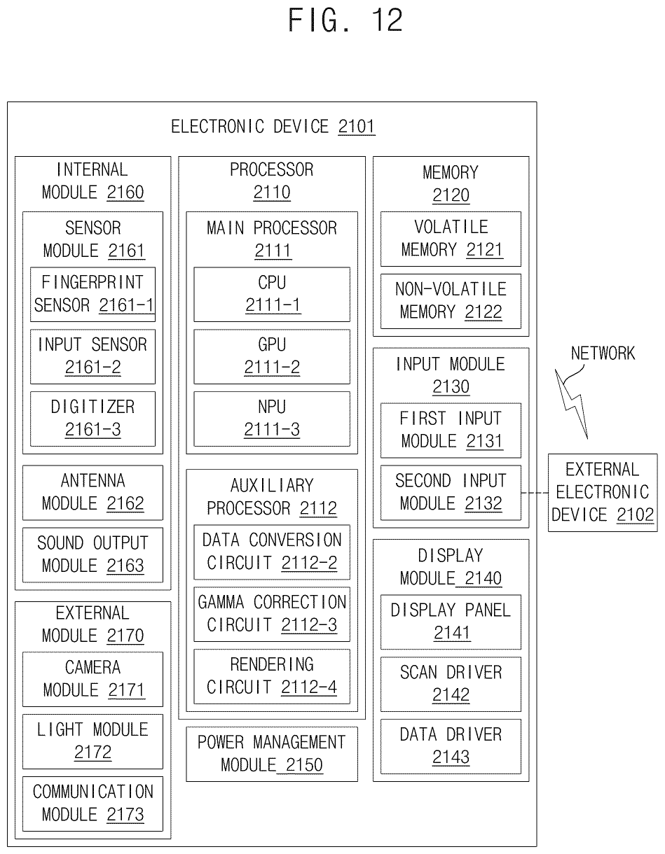

FIG. 12 is a block diagram illustrating an example of an electronic device, according to an embodiment.

In an embodiment, an electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

In another embodiment, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

In still yet another embodiment, when a music streaming icon displayed on the display module 2140 is selected, the processor 2110 obtains a user input via the input sensor 2161-2 and may activate a music streaming application stored in the memory 2120. When a music execution command is input into the music streaming application, the processor 2110 may activate a sound output module 2163 to provide sound information corresponding to the music execution command to the user.

In the above, operations of the electronic device 2101 has been briefly described. Hereinafter, a configuration of the electronic device 2101 will be described in detail. Some components of the electronic device 2101 described below may be integrated and provided as one component, or one component may be provided separately as two or more components.

In an embodiment and referring to FIG. 12, the electronic device 2101 may communicate with an external electronic device 2102 via a network (e.g., a short-range wireless communication network or a long-range wireless communication network). In some embodiments, the electronic device 2101 may include the processor 2110, the memory 2120, the input module 2130, the display module 2140, a power management module 2150, an internal module 2160 and an external module 2170. In some embodiments, at least one of the components may be omitted from the electronic device 2101, or one or more other components may be added in the electronic device 2101. In some embodiments, some of the components (e.g., the sensor module 2161, an antenna module 2162, or the sound output module 2163) may be implemented as a single component (e.g., the display module 2140).

The processor 2110 may execute software to control at least one other component (e.g., a hardware or software component) of the electronic device 2101 coupled with the processor 2110 and may perform various data processing or computation. According to some embodiments, as at least part of the data processing or computation, the processor 2110 may store a command or data received from another component (e.g., the input module 2130, the sensor module 2161 or a communication module 2173) in volatile memory 2121, may process the command or the data stored in the volatile memory 2121, and may store resulting data in non-volatile memory 2122.

The processor 2110 may include a main processor 2111 and an auxiliary processor 2112. The main processor 2111 may include one or more of a central processing unit (CPU) 2111-1 or an application processor (AP). The main processor 2111 may further include any one or more of a graphics processing unit (GPU) 2111-2, a communication processor (CP), and an image signal processor (ISP). The main processor 2111 may further include a neural processing unit (NPU) 2111-3. The NPU 2111-3 may be a processor specialized in processing an artificial intelligence model, and the artificial intelligence model may be generated through machine learning. The artificial intelligence model may include a plurality of artificial neural network layers, where the artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or in another embodiment, include a software structure other than a hardware structure. At least two of the above-described processing units and processors may be implemented as an integrated component (e.g., a single chip), or respective processing units and processors may be implemented as independent components (e.g., a plurality of chips).

The auxiliary processor 2112 may include a controller, where the controller may include an interface conversion circuit and a timing control circuit. The controller may receive an image signal from the main processor 2111, may convert a data format of the image signal to meet interface specifications with the display module 2140, and may output image data. The controller may output various control signals required for driving the display module 2140.

The auxiliary processor 2112 may further include a data conversion circuit 2112-2, a gamma correction circuit 2112-3, a rendering circuit 2112-4, or the like. The data conversion circuit 2112-2 may receive image data from the controller and may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller and may render the image data in consideration of a pixel arrangement of the display panel 2141 in the electronic device 2101. In an embodiment, at least one of the data conversion circuit 2112-2, the gamma correction circuit 2112-3 and the rendering circuit 2112-4 may be integrated with another component (e.g., the main processor 2111 or the controller). In an embodiment, at least one of the data conversion circuit 2112-2, the gamma correction circuit 2112-3 and the rendering circuit 2112-4 may be integrated with a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In some embodiments, the second input module 2132 may include a high definition multimedia interface (HDMI), a universal serial bus (USB) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is limited thereto. The display panel 2141 may be a rigid type display panel, or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. In another embodiment, the scan driver 2142 may be integrated into the display panel 2141. For example, the scan driver 2142 may include an amorphous silicon TFT gate driver circuit (ASG), a low temperature polycrystalline silicon (LTPS) TFT gate driver circuit or an oxide semiconductor TFT gate driver circuit (OSG) embedded in the display panel 2141. The scan driver 2142 may receive a control signal from the controller and may output scan signals to the display panel 2141 in response to the control signal.

The display panel 2141 may further include an emission driver, where the emission driver may output an emission control signal to the display panel 2141 in response to a control signal received from the controller. The emission driver may be formed separately from the scan driver 2142 or may be integrated into the scan driver 2142.

The data driver 2143 may receive a control signal from the controller, may convert image data into analog voltages (e.g., data voltages) in response to the control signal, and then may output the data voltages to the display panel 2141.

The data driver 2143 may be incorporated into other components (e.g., the controller). Furthermore, the functions of the interface conversion circuit and the timing control circuit of the controller described above may be integrated into the data driver 2143.

The display module 2140 may further include the emission driver, a voltage generator circuit, or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable, or a fuel cell. The power management module 2150 may include a power management integrated circuit (PMIC). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131 and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen or may transmit/receive data to/from the active pen.

The input sensor 2161-2 may measure a bio-signal, such as blood pressure, moisture or body fat. For example, when a portion of the body of the user touches a sensor layer or a sensing panel and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141, or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In some embodiments, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor or an illuminance sensor.

The antenna module 2162 may include one or more antennas for transmitting or receiving a signal or power to or from the outside. In some embodiments, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing a recording. The receiver may be used for receiving incoming calls. In some embodiments, the receiver may be implemented as separate from, or as part of the speaker. A sound output pattern of the sound output module 2163 may be integrated into the display module 2140.

The camera module 2171 may capture a still image and a moving image. In some embodiments, the camera module 2171 may include one or more lenses, an image sensor or an image signal processor. The camera module 2171 may further include an infrared camera capable of measuring the presence or absence of the user, the user's location and the user's line of sight.

The light module 2172 may provide light and may include a light emitting diode or a xenon lamp. The light module 2172 may operate in conjunction with the camera module 2171 or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (GNSS) communication module) or a wired communication module (e.g., a local area network (LAN) communication module or a power line communication (PLC) module). The communication module 2173 may communicate with the external electronic device 2102 via a short-range communication network (e.g., Bluetooth™, wireless-fidelity (Wi-Fi) direct, or infrared data association (IrDA)) or a long-range communication network (e.g., a cellular network, the Internet or a computer network (e.g., LAN or wide area network (WAN)). These various types of communication modules 2173 may be implemented as a single chip or may be implemented as multi-chips that are separate from each other.

The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, in an embodiment, the processor 2110 may generate image data corresponding to input data applied through a mouse or an active pen, and may output the image data to the display module 2140. In another embodiment, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120, and then may execute an application according to the comparison result.

The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161 and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (GPIO), serial peripheral interface (SPI), mobile industry processor interface (MIPI) or ultra-path interconnect (UPI)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication methods.

The electronic device 2101, according to various embodiments described above, may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101, according to embodiments, is not limited to the above-described devices.

The foregoing is illustrative of embodiments of the invention and is not to be construed as limiting thereof. Although a few embodiments have been described, those skilled in the art will readily appreciate that many modifications are possible in the embodiments without materially departing from the novel teachings and advantages of the invention. Accordingly, all such modifications are intended to be included within the scope of the invention. Therefore, it is to be understood that the foregoing is illustrative of various embodiments and is not to be construed as limited to the specific embodiments disclosed, and that modifications to the disclosed embodiments, as well as other embodiments, are intended to be included within the scope of the invention. Moreover, the embodiments or parts of the embodiments may be combined in whole or in part without departing from the scope of the invention.

What is claimed is:

1. A display device comprising:
a display panel including a pixel; and
a panel driver configured to apply an initialization voltage to the pixel in a first pre-charge period which is included in an active period of a frame period, to apply a data voltage to the pixel, to perform a sensing operation to the pixel in a sensing period which is included in a blank period of the frame period, to apply the initialization voltage to the pixel in a second pre-charge period which is included in the blank period and to apply a previous data voltage to the pixel in a previous frame writing period which is included in the blank period,
wherein the panel driver is further configured to change one of a length of the first pre-charge period and a length of the second pre-charge period based on a frame rate.

2. The display device of claim 1, wherein, after the previous data voltage is applied in the blank period, a gate-source voltage of a driving transistor of the pixel is equal to or less than a gate-source voltage of the driving transistor of the least one pixel in the active period.

3. The display device of claim 1, wherein the panel driver is configured to change the length of the first pre-charge period based on a first look-up table in which the first pre-charge period gradually decreases as the frame rate increases.

4. The display device of claim 1, wherein the panel driver is configured to change the length of the second pre-charge period based on a second look-up table in which the second pre-charge period gradually increases as the frame rate increases.

5. The display device of claim 1, wherein the panel driver is configured to increase the length of the first pre-charge period compared with a length of a reference pre-charge period, and to decrease the length of the second pre-charge period compared with the length of the reference pre-charge period.

6. The display device of claim 5, wherein as the frame rate decreases, the panel driver is configured to further increase the length of the first pre-charge period, and to further decrease the length of the second pre-charge period.

7. The display device of claim 1, wherein the pixel comprises:
a driving transistor including a gate connected to a gate node, a first terminal connected to a line of a first supply voltage and a second terminal connected to a source node;
a scan transistor including a gate receiving a scan signal, a first terminal connected to a data line and a second terminal connected to the gate node;
a sensing transistor including a gate receiving a sensing signal, a first terminal connected to a sensing line and a second terminal connected to the source node;
a storage capacitor including a first electrode connected to the gate node and a second electrode connected to the source node; and
a light emitting element including an anode connected to the source node and a cathode connected to a line of a second power supply voltage.

8. The display device of claim 1, wherein the panel driver comprises:
a frame rate determining circuit configured to determine the frame rate of the display panel;
a pre-charge set-up circuit configured to receive a maximum frame rate of the display panel and a minimum frame rate of the display panel and to output a final pre-charge look-up table;
a timing controller configured to receive a present frame rate from the frame rate determining circuit, to receive the final pre-charge look-up table from the pre-charge set-up circuit and to output a gate width signal; and
a signal generator configured to receive the gate width signal and to output a scan signal and a sensing signal.

9. The display device of claim 8, wherein the pre-charge set-up circuit comprises:
a first pre-charge set-up circuit configured to receive the maximum frame rate and the minimum frame rate and to generate a first look-up table in which the first pre-charge period gradually decreases as the frame rate increases; and
a second pre-charge set-up circuit configured to receive the maximum frame rate and the minimum frame rate and to generate a second look-up table in which the second pre-charge period gradually increases as the frame rate increases,
wherein the final pre-charge look-up table is generated based on the first look-up table and the second look-up table.

10. The display device of claim 8, wherein in the first pre-charge period, the timing controller is configured to increase a length of a gate width signal activation level period to be larger than a length of a reference gate width signal activation level period, and
wherein in the second pre-charge period, the timing controller is configured to decrease the length of the gate width signal activation level period to be smaller than the length of the reference gate width signal activation level period.

11. The display device of claim 10, wherein the signal generator is configured to output the scan signal and the sensing signal having an activation level in the gate width signal activation level period.

12. The display device of claim 10, wherein as the frame rate decreases, in the first pre-charge period, the timing controller is configured to further increase a length of a gate width signal activation level period, and
wherein as the frame rate decreases, in the second pre-charge period, the timing controller is configured to further decrease the length of the gate width signal activation level period.

13. The display device of claim 12, wherein the signal generator is configured to output the scan signal and the sensing signal having an activation level in the gate width signal activation level period.

14. A display device comprising:
a display panel including a pixel including a driving transistor, a scan transistor, a sensing transistor and a light emitting element; and
a panel driver configured to apply an initialization voltage to the driving transistor through the sensing transistor in a first pre-charge period which is included in an active period of a frame period, to apply a data voltage to the driving transistor through the scan transistor in a data writing period which is included in the active period, to perform a sensing operation to the driving transistor in a sensing period which is included in a blank period of the frame period, to apply the initialization voltage to the driving transistor through the sensing transistor in a second pre-charge period which is included in the blank period and to apply a previous data voltage to the driving transistor through the scan transistor in a previous frame writing period which is included in the blank period,
wherein a length of the first pre-charge period and a length of the second pre-charge period are different from each other.

15. A method of operating a display device, the method comprising:
changing one of a length of a first pre-charge period which is included in an active period of a frame period and a length of a second pre-charge period which is included in a blank period of the frame period based on a present frame rate;
applying an initialization voltage to at least one pixel of pixels in the first pre-charge period;
sequentially applying data voltages to the pixels on a row basis in a data writing period which is included in the active period;
performing a sensing operation on the at least one pixel in a sensing period which is included in the blank period;
applying the initialization voltage to the at least one pixel in the second pre-charge period; and
applying a previous data voltage to the at least one pixel in a previous frame data writing period which is included in the blank period.

16. The method of claim 15, wherein a gate-source voltage of a driving transistor of the at least one pixel after the previous data voltage is applied in the blank period is equal to or less than a gate-source voltage of the driving transistor of the at least one pixel in the active period.

17. The method of claim 15, wherein the length of the first pre-charge period is increased compared with a length of a reference pre-charge period and the length of the second pre-charge period is decreased compared with the length of the reference pre-charge period.

18. The method of claim 17, wherein the length of the first pre-charge period is gradually decreased as the present frame rate increases, and
wherein the length of the second pre-charge period is gradually increased as the present frame rate increases.

19. The method of claim 17, wherein as the frame rate decreases, the length of the first pre-charge period is further increased and the length of the second pre-charge period is further decreased.

20. The method of claim 19, wherein, as the present frame rate increases, the first pre-charge period is gradually decreased, and the second pre-charge period is gradually increased.
